(19) United States
(12) Patent Application Publication
(10) Pub. No.: US 2012/0099958 A1
(43) Pub. Date: Apr. 26, 2012

(54) GRIPPING SYSTEM AND METHOD OF GRIPPING AND LIFTING OBJECTS

(75) Inventors: Michael Lang, Buching (DE); Uwe Geiger, Bad Groenenbach (DE)

(73) Assignee: MULTIVAC SEPP HAGGENMUELLER GMBH & CO. KG, Wolfertschwenden (DE)

(21) Appl. No.: 13/277,554

(22) Filed: Oct. 20, 2011

(30) Foreign Application Priority Data
Oct. 21, 2010 (DE) 10 2010 049 192.6

(51) Int. Cl. B66C 1/00; B66C 13/00

(52) U.S. Cl. 414/785; 414/800

(57) ABSTRACT

The disclosure relates to a gripping system comprising a gripper for gripping and lifting at least one object to be gripped. This object may be a package. The disclosure is characterized in that the gripping system is provided with a downholder which is configured for holding down at least one object located adjacent the object to be gripped, while the object to be gripped is being lifted. The disclosure also relates to a packaging machine provided with such a gripping system, as well as to a method of gripping and lifting a track or row of packages by means of a gripping system.

### CROSS-REFERENCE TO RELATED APPLICATIONS

This application claims foreign priority under 35 U.S.C. §119(a)-(d) to German patent application number DE 102010049192.6, filed Oct. 21, 2011, which is incorporated by reference in its entirety.

### TECHNICAL FIELD

The disclosure relates to a gripping system according to the preamble of claim 1 as well as to a packaging machine comprising such a gripping system and to a method of gripping and lifting a track or row of packages by means of a gripping system.

### BACKGROUND

EP 0 530 426 A1 discloses grippers for picking up a plurality products by pushing gripper arms under respective products while downholders hold down the products to be gripped themselves so as to protect them against shifting. EP 0 629 573 A1 shows a gripper used for picking up a stack of blanks, a unit for holding the uppermost blank by means of a plurality of suction cups being provided here.

In order to achieve high efficiency, a large number of packages is often produced simultaneously in one work cycle in packaging machines. For example, a plurality of packages is closed simultaneously in one work cycle in a closing station of the packaging machine. The whole group of closed packages is subsequently provided on a discharge surface or a discharge conveyor. Between the closing and the provision on the discharge surface, the formerly interconnected packages may perhaps also be separated from one another.

In order to be able to produce a group of packages simultaneously, a packaging machine can be capable of producing a plurality of tracks of packages extending side by side. In addition, a plurality of successive rows of packages can be treated simultaneously in the working tools of the packaging machine. This allows n×m packages to be treated or produced simultaneously in one work cycle, viz. a group of packages consisting of n tracks and m rows, n and m being integers and having, for example, a value from 1 to 10. For example, fifteen packages can thus be treated or produced in a single working step, said fifteen packages being comprised in three side-by-side tracks and in five successive rows.

After having been produced, the packages must often be separated from one another, for example, for examining the individual packages with respect to quality or weight. A comparatively complicated variant is so conceived that a discharge conveyor comprises a separate conveyor belt for each track of packages. When the individual conveyor belts are adapted to be driven independently of one another, one track of packages after the next can be removed.

According to a different technique, individual packages or a group of packages are raised from the discharge conveyor or discharge surface by means of a gripping system so as to feed them to a location where they are separated from one another. This technique, however, entails the problem that the packages do not have defined positions relative to one another when they are being removed, since their movement depends, for example, on the inhomogeneous distribution of the product within the individual packages. This has the effect that the packages may be displaced or rotated so that neighboring packages may overlap in the transport direction and/or transversely to the transport direction. When a package or group of packages is then raised by means of the gripping system, the problem may occasionally be that neighboring, overlapping packages are raised so that they may rotate or undergo an uncontrolled change of position, whereupon automatic transport of such packages will no longer be possible.

### SUMMARY

It is an object of the present disclosure to remedy the above problem making use of means which have the simplest possible structural design.

A gripping system according to the present disclosure is characterized in that it is provided with a downholder which is configured for holding down at least one object located adjacent the object to be gripped, while the object to be gripped (e.g. a package) is being lifted. Even if the held-down object should be in contact with, or even overlap the object to be gripped, the downholder will prevent, limit or decelerate a movement of the held-down object. Thus, it can be reliably prevented that a movement of the gripped object impairs the neighboring objects or even leads to an uncontrolled change in position of the neighboring objects.

Preferably, the gripper is configured for gripping a plurality of objects, and the downholder is configured for holding down a plurality of objects. The removal of objects, such as packages from a packaging machine, can be substantially accelerated in this way. For separating the individual objects from one another, it would be imaginable to implement the gripper such that individual objects can be released in a temporally staggered fashion.

According to one variant of the present disclosure, the gripper is configured for gripping a track of objects, and the downholder is, analogously, configured for holding down a track of objects. This variant is particularly suitable for a packaging machine in which packages are produced and provided in a plurality of side-by-side tracks. By means of the gripper a respective track of objects can be gripped and removed. In this way, one track after the other can be removed.

It will be advantageous when the gripper comprises at least one suction gripping head for gripping a single object. Such a suction gripping head has the advantage that it can be applied to the object from above. Especially when some of the objects are located close to one another, it is thus possible to prevent objects located adjacent the objects to be gripped from being impaired and inadvertently displaced.

The downholder may comprise an elastically yielding surface at which it enters into contact with the object to be held down or with the objects to be held down. The elastically yielding characteristics of the contact surface prevent the objects to be held down from being damaged. This is of advantage especially when damageable or irregularly shaped objects are dealt with.

In one embodiment, the elastically yielding surface of the downholder which comes into contact with the objects may be a surface of a foam layer. This embodiment is particularly simple.

Alternatively, the elastically yielding surface may be the surface of a plate or strip supported by a foam layer, at least one spring, an air cushion and/or some other elastic element. In the case of this embodiment it may suffice when the plate or strip is elastically supported at only a few—e.g., two or three—points.

According to a comparatively simple embodiment, the downholder is always coupled to the movement of the gripper. This is advantageous insofar as the downholder will be lowered onto objects to be held down precisely at the time at which the gripper is lowered onto objects to be gripped. It is thus guaranteed with little constructional outlay that the downholder will always enter into contact with objects simultaneously with or in a defined temporal relation to the gripper.

Alternatively, it would be imaginable that the gripper is adapted to be moved, at least over part of its range of movement, independently of the downholder. This variant requires a little more constructional outlay, but it has the advantage that the downholder will be able to longer hold down the objects to be held down, even when the movement of the gripper has started.

According to the last-mentioned variant, it would be possible to configure the gripper for executing a horizontal and/or a pivotal movement independently of a movement of the downholder. By means of this kind of movement, objects gripped by the gripper could, for example, be removed laterally from the held-down objects or pivoted away from the held-down objects.

The disclosure also relates to a packaging machine comprising a gripping system of the type described hereinbefore. In this case, the objects are packages that have previously been produced by means of the packaging machine.

In addition, the disclosure relates to a method of gripping and lifting a track of packages by means of a gripping system. This method is so conceived that the movement of a track of packages located adjacent the track of packages to be gripped is restricted and/or decelerated when said track of packages to be gripped is being moved by the gripping system. In particular, it would be imaginable that the track of packages whose movement is restricted and/or decelerated is held down, i.e. prevented from executing a vertical movement, or that the held-down packages are even prevented from executing any movement whatsoever.

The gripping system according to the disclosure cannot only be used on packaging machines or for packages, but the gripped and held-down objects may be any kind of objects in the case of which a displacement of objects located adjacent the objects to be gripped is to be prevented.

In the following, advantageous embodiments of the present disclosure will be explained in more detail on the basis of the below drawings.

### BRIEF DESCRIPTION OF THE DRAWINGS

FIG. 1 is a top view of a group of 3×6 packages produced simultaneously by a packaging machine;

FIG. 2 is a schematic, perspective view of a first embodiment of a gripping system according to the present disclosure;

FIG. 3 is a schematic front view of the gripping system shown in FIG. 2;

FIG. 4 is a schematic, perspective view of a second embodiment of a gripping system according to the present disclosure; and

FIG. 5 is a schematic front view of the gripping system shown in FIG. 4.

### DETAILED DESCRIPTION

Identical components have been provided with identical reference numerals throughout the figures.

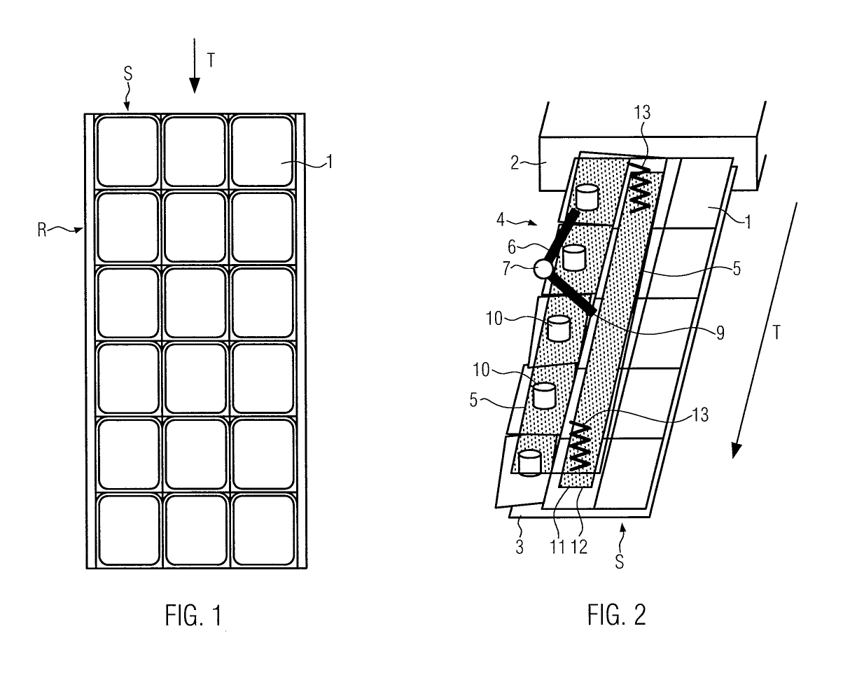

FIG. 1 shows a top view of a group of eighteen packages 1 which have been produced simultaneously in one work cycle in a packaging machine 2 (cf. FIG. 2). The group of eighteen packages 1 is transported in a transport direction T, indicated by the arrow, within the packaging machine 2 and out of the packaging machine 2. The packages 1 are transported on three tracks side by side in the transport direction T and in six rows R staggered one behind the other in the transport direction T. Neighboring packages 1 can be separated from one another by longitudinal and/or transverse cuts. It is also imaginable that the cutting units used for separating the packages 1 from one another produce a distance of a few millimeters, e.g., four millimeters, between neighboring packages 1 so as to facilitate separation of the packages 1 later on.

FIG. 2 shows in a schematic representation a packaging machine 2 according to the present disclosure that produces packages 1 which are also shown only in a very schematic fashion. After having been finished, the packages 1 are conveyed in the transport direction T onto a discharge plane 3, which may also be a discharge conveyor. The whole group of n×m packages, in the present case fifteen packages 1, which are arranged on n=3 tracks S and in m=5 rows, reaches the discharge plane 3 at the same time. In FIG. 2 it can be seen that the packages 1 are not neatly arranged on the discharge plane 3, but the packages 1 may be slightly rotated relative to one another and, in some cases, overlapping between packages 1 that are positioned side by side or one after the other may also occur.

FIG. 2 shows in a schematic representation certain components of a gripping system 4 according to the present disclosure. This gripping system 4 is arranged above the discharge plane 3. It comprises a gripper 5, in the present case in the form of a horizontally oriented gripper plate 5. The length of this gripper plate 5 approximately corresponds to the length of five successive packages 1 on the discharge plane 3, and the width of the gripper plate 5 almost corresponds to the width of two juxtaposed tracks S of packages 1. A kinematic unit 6, in the present embodiment a toggle lever mechanism 6 with two arms 8 connected via an elbow joint 7, has its lower end connected to the gripper plate 5 via a further joint 9. By means of a pivotal movement of the arms 8 about the joint 7, the kinematic unit 6 causes the gripper plate 5 to be raised or lowered. Means are provided for maintaining the gripper plate 5 always in a horizontal orientation.

Above the track S of packages 1 constituting the outermost left track S in FIG. 2, the lower surface of the gripper plate 5 has provided thereon a number of suction gripping heads 10 corresponding to the number of packages 1 on the track S. Each suction gripping head 10 can have applied thereto a negative pressure or vacuum for applying a suction force to the upper surface of a package 1. The suction force that can be accomplished by means of the suction gripping heads 10 exceeds the weight of the filled package 1. Vacuum lines (not shown) can extend from a common vacuum source via the kinematic unit 6 to the gripper plate 5 and from there via suitable manifolds to the individual suction gripping heads 10 so as to activate all the suction gripping heads 10 at the same time. Furthermore, each suction gripping head 10 can have provided thereon a separately controllable shut-off valve. By means of such a separately controllable shut-off valve, each suction gripping head 10 can be deactivated individually so as to release the package 1 held thereby. Such a temporally staggered release of the packages 1 held by the gripping system 4 allows and facilitates a separation of the individual packages 1.

In addition to the row of suction gripping heads 10, the gripper 5, and in particular the lower surface of the gripper plate 5, has provided thereon a holding device, such as a downholder 11. This downholder 11 serves to hold down the middle track S of packages 1, while the left track S of packages is gripped by the suction gripping heads 10 and possibly raised. To this end, the downholder 11 is provided with a downholder plate 12, which has the same length as the gripper plate 5, i.e., which extends over almost the entire length of the middle track S of packages 1. The front and rear areas of the downholder plate 12 are each supported via a respective elastic compression spring 13 relative to the gripper plate 5.

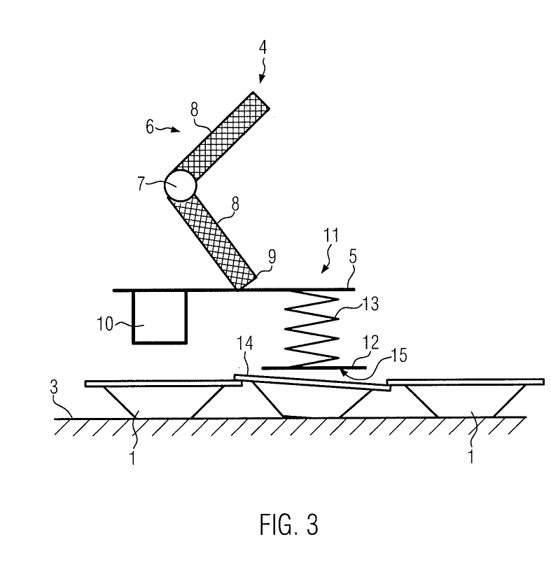

FIG. 3 shows a schematic front view of the gripping system 4 shown in FIG. 2. First of all, it can be seen that the three packages 1, which are juxtaposed in a row R, overlap in the area of their edges 14. The edge 14 of the middle package 1 lies over the edge of the left package 1. If the left package 1 were raised, the middle package 1 might tilt still further, raise or slip still further below the right package 1. The downholder 11 according to the present disclosure, which is arranged on the gripping system 4, is provided for the purpose of inhibiting or preventing this.

The lower surface of the downholder strip 12 defines a contact surface 15 at which the downholder 11 enters into contact with the packages 1 to be held down. This contact surface 15 is supported elastically relative to the gripper plate 5 by means of the compression springs 13. The length of the compression spring 13 is dimensioned such that the contact surface 15 projects from the gripper plate 5 downwards beyond the lower surface of the suction gripping heads 10. This has the effect that, when the gripper plate 5 is lowered by means of the kinematic unit 6, the contact surface 15 will enter into contact with the packages 1 to be held down before the suction gripping heads 10 can apply a suction force to and take hold of the packages 1 to be gripped. The elasticity of the compression springs 13 additionally guarantees that the packages 1 to be held down will not be damaged, since the contact surface 15 of the downholder strip 12 is able to adapt itself to the orientation of the upper surfaces of the packages 1. The length of the compression springs 13 also guarantees that, during a first lifting step of the packages 1 gripped by means of the suction gripping heads 10, the packages 1 to be held down will remain held down. This allows the gripped packages 1 to move safely upwards beyond the edges 14 of the held-down packages 1. When the gripping system 4 then moves further upwards or further to the side, a risk of displacement of the held-down packages 1 no longer exists.

FIG. 4 shows a second embodiment of a gripping system 4 according to the present disclosure. It differs from the first embodiment insofar as the downholder 11 and the suction gripping heads 10 are now no longer secured to a common gripper plate 5, but the downholder 11 is secured to a downholder plate 16 of its own, i.e. the gripper 5 and the downholder 11 are here independent of one another. The downholder plate 16 is movable via a separate kinematic unit 6′ (in the present case again a toggle lever mechanism) independently of the kinematic unit 6 of the gripper 5. In correspondence with the first embodiment, a downholder strip 12 is secured in position below the downholder plate 16 via two compression springs 13. The lower surface of said downholder strip 12 serves as a contact surface 15 with which the downholder 11 enters into contact with the packages 1 to be held down.

In the second embodiment, the gripper plate 5 has a width which is slightly smaller than the width of a track S of packages 1. The lower surface of the gripper plate 5 carries again five successive suction gripping heads 10 for applying a suction force to the packages 1 to be gripped and for holding them on the gripper plate 5.

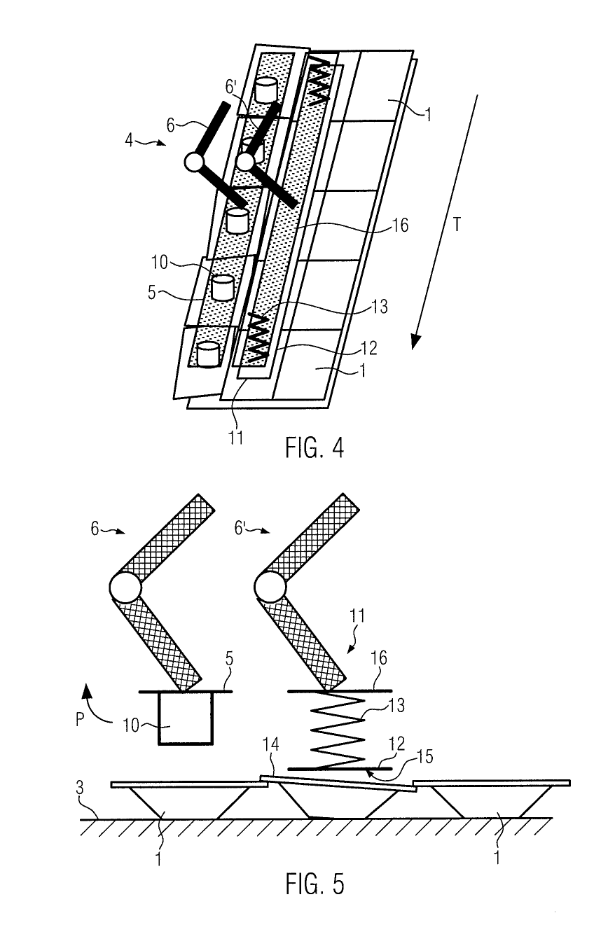

FIG. 5 shows a schematic front view of the embodiment shown in FIG. 4. In FIG. 5 it can be seen again that, in contrast to the first embodiment, a gripper plate 5 and a downholder plate 16 are provided separately from one another and can be moved independently of one another by means of a respective separate kinematic unit 6, 6′. The kinematic units 6, 6′ may be provided on a common robot (e.g., a delta robot) or on two separate robots.

The method according to the present disclosure and the operation of the packaging machine 2 with the gripping system 4 according to the present disclosure take place as described hereinbelow.

In the packaging machine 2 a group of packages 1 is produced, which are arranged on n tracks S side by side and in m successive rows R. Such a group of packages 1 may, for example, comprise three tracks and five or six rows R. This group of packages 1 is transported onto a discharge plane 3 from which the packages 1 are to be fed to a location where they are separated from one another. When the group of packages 1 is located on the discharge plane 3, it may happen that the edges 14 of juxtaposed packages 1 overlap.

The gripping system 4 according to the present disclosure is now lowered onto the group of packages 1 from above. In so doing, the gripper plate 5 is lowered by means of the kinematic unit 6 such that the suction gripping heads 10 are located above the outermost left track S of packages 1. In the first embodiment, a downward movement of the gripper plate 5 has the effect that also the downholder 11 will be lowered and act with its contact surface 15 on the middle track S of packages 1 to be held down before the suction gripping heads 10 grip and move the packages 1 to be gripped. In the second embodiment, the downholder plate 16 is lowered by means of its kinematic unit 6′ parallel to the gripper plate 5 so as to first establish, also in this case, a contact with the track of packages 1 to be held down.

When the middle track S of packages 1 to be held down has been contacted by means of the contact surface 15, the movement possibilities of these held-down packages 1 are decelerated or limited, since said packages 1 can now only move against the force applied by the compression spring 13 and against the friction forces between the package 1 and the contact surface 15. The gripper plate 5 is now lowered still further until the suction gripping heads 10 enter into contact with the packages 1 to be gripped and, after having been activated, apply a suction force to these packages 1 thus holding them on the gripping system 4. The gripper plate 5 is now raised again. In the course of this movement, the gripped packages 1 move past the edges 14 of the held-down packages 1. In the second embodiment of the gripping system 4, a lateral (pivotal) movement, indicated by the arrow P, can take place instead of or in addition to an upward movement, without any movement of the downholder plate 16 taking place and without any changes occurring in the downholding force acting on the held-down packages 1.

As soon as the gripped packages 1 have been detached from the held-down packages 1, the gripped packages 1 can be moved on by means of the gripping system 4, e.g., onto a discharge conveyor. There, the gripped packages 1 can be released simultaneously or in a temporally staggered fashion. In the second embodiment, the downholder plate 16 is raised by means of its kinematic unit 6′ as soon as the left track S of packages 1 has moved away a sufficiently large distance.

As soon as the gripping system 4 has released the gripped, left track of packages 1, it grips in the manner described hereinbefore the previously held-down middle track S of packages 1. At the same time, the downholder 11 only holds down the right track S of packages 1. This process is repeated until all track S of packages 1 have been removed.

Starting from the embodiments shown, the packaging machine 2 according to the present disclosure and the gripping system 4 according to the present disclosure as well as the method according to the present disclosure can be modified in many respects. For example, the gripper and downholder plates 5, 16 need not actually be plates, but they may also be frames, tubes or other structures. Instead of the downholder strip 12, also a compression spring 13 may be provided for each individual package 1 to be held down. Instead of the compression springs 13 or in addition thereto, a foam layer may be provided between the gripper or downholder plate 5, 16 and the downholder strip 12, said foam layer being, like the compression springs 13, used as an elastically yielding support of the downholder strip 12. It would also be imaginable to dispense with the downholder strip 12 so that now the surface of the foam layer itself represents the contact surface 15 by means of which the downholder 11 enters into contact with the packages 1 to be held down.

In an embodiment of the present disclosure, it would also be possible that the gripping system 4 and the downholder 11 are configured for gripping and holding down not a track S of packages 1 but a row R of packages 1. Other than in the case of the representations in FIGS. 2 and 4, the gripper and downholder plates 5, 16 would then not be oriented in the transport direction T, but transversely to said transport direction T. In the case of such a variant of the present disclosure, the row R of packages 1 would be removed from the discharge plane 3 from the front to the back, for example.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A gripping system comprising:
a gripper for gripping and lifting at least one object to be gripped; and
a downholder that is configured for holding down at least one object located adjacent the at least one object to be gripped, while the at least one object to be gripped is being lifted.

2. A gripping system according to claim 1 wherein the gripper is configured for gripping a plurality of objects, and the downholder is configured for holding down a plurality of objects.

3. A gripping system according to claim 1 wherein the gripper is configured for gripping a track or row of objects, and the downholder is configured for holding down a track or row of objects.

4. A gripping system according to claim 1 wherein the gripper comprises at least one suction gripping head for gripping one of the at least one object to be gripped.

5. A gripping system according to claim 1 wherein the downholder comprises an elastically yielding surface.

6. A gripping system according to claim 5 wherein the elastically yielding surface is a surface of a foam layer.

7. A gripping system according to claim 5 wherein the elastically yielding surface is a surface of a plate or strip supported by a foam layer and/or at least one spring.

8. A gripping system according to claim 1 wherein the downholder is coupled to movement of the gripper.

9. A gripping system according to claim 1 wherein the gripper is adapted to be moved, at least over part of its range of movement, independently of the downholder.

10. A gripping system according to claim 9 wherein the gripper is configured for executing a horizontal movement and/or a pivotal movement independently of a movement of the downholder.

11. A packaging machine comprising a gripping system according to claim 1.

12. A method of gripping and lifting packages by a gripping system, the method comprising:
gripping a track or row of packages;
lifting the gripped track or row of packages; and
restricting and/or decelerating movement of a track or row of packages located adjacent the gripped track or row of packages when the gripped track or row of packages is being moved by the gripping system.

13. A method according to claim 12 wherein restricting and/or decelerating movement of the track or row of packages located adjacent the gripped track or row of packages comprises holding down the track or row of packages located adjacent the gripped track or row of packages.

14. A method according to claim 12 wherein the gripping and lifting steps are performed using a gripper of the gripping system, and the restricting and/or decelerating movement step is performed using a holding device of the gripper system.

15. A gripping system comprising:
a gripper for gripping and lifting a first object; and
a holding device that is configured for holding down a second object located adjacent the first object, while the first object is being lifted.

16. The gripping system of claim 15 wherein the gripper and the holding device are coupled together such that the gripper and the holding device move together.

17. The gripping system of claim 15 wherein the gripper and the holding device are movable independently of each other.
